(19) United States
(12) Patent Application Publication
(10) Pub. No.: US 2013/0148097 A1
(43) Pub. Date: Jun. 13, 2013

(54) DISTANCE MEASURING SENSOR

(71) Applicants: Jae-sung SHIN, Hwaseong-si (KR); Hyoung-soo KO, Hwaseong-si (KR); Shin-wook Yi, Hwaseong-si (KR)

(72) Inventors: Jae-sung SHIN, Hwaseong-si (KR); Hyoung-soo KO, Hwaseong-si (KR); Shin-wook Yi, Hwaseong-si (KR)

(73) Assignee: SAMSUNG ELECTRONICS CO., LTD., Suwon-si (KR)

(21) Appl. No.: 13/604,335

(22) Filed: Sep. 5, 2012

(30) Foreign Application Priority Data
Dec. 12, 2011 (KR) 10-2011-0133054

(51) Int. Cl. G01C 3/08

(52) U.S. Cl. 356/4.01

(57) ABSTRACT

A distance measuring sensor includes a substrate doped with a first impurity, first and second charge storage regions spaced apart from each other in the substrate and doped with a second impurity, a photoelectric conversion region doped with the second impurity between the first and the second charge storage regions and configured to receive light to generate charges, a first dielectric layer covering the first and second charge storage regions and the photoelectric conversion region, a second dielectric layer on the first dielectric layer, and first and second transfer gates spaced apart from each other on the first dielectric layer and between the first and second charge storage regions. Each of the first and second transfer gates may cover a portion of the second dielectric layer and may be configured to selectively transfer the charges generated in the photoelectric conversion region to the first and second charge storage regions.

### CROSS-REFERENCE TO RELATED APPLICATIONS

This application claims the benefit of Korean Patent Application No. 10-2011-0133054, filed on Dec. 12, 2011, in the Korean Intellectual Property Office, the disclosure of which is incorporated herein in its entirety by reference.

### BACKGROUND

1. Field

Example embodiments relate to a distance measuring sensor, and more particularly, to a distance measuring sensor including a plurality of dielectric layers.

2. Description of the Related Art

Portable devices including image sensors, e.g., digital cameras and mobile communication terminals, have recently been developed and purchased. To capture a three-dimensional (3D) image of an object by using an image sensor, color information of an object and information regarding a distance between the object and the image sensor are required. In the corresponding field, an image representing the distance between an object and an image sensor generally refers to a depth image, and the depth image can be obtained using infrared light beyond the visible light region.

A representative method of acquiring information regarding a distance between an image sensor and an object is a time-of-flight (TOF) method whereby a travelling time of light is measured by irradiating light onto an object and sensing the reflected light. The TOF-based depth capturing technology is a method whereby a phase variation is detected when an irradiated light with a modulated pulse is reflected from an object, and a rapid demodulation speed is required for accurate calculation of TOF.

### SUMMARY

Example embodiments provide a distance measuring sensor for rapidly transferring charges generated by reflected light to a charge storage region.

According to example embodiments, a distance measuring sensor may include a substrate doped with a first impurity, first and second charge storage regions spaced apart from each other in the substrate, a photoelectric conversion region between the first and the second charge storage regions, a first dielectric layer covering the first and second charge storage regions and the photoelectric conversion region, a second dielectric layer on the first dielectric layer, and first and second transfer gates spaced apart from each other on the first dielectric layer and between the first and second charge storage regions. Each of the first and second transfer gates may cover a portion of the second dielectric layer and configured to selectively transfer the charges generated in the photoelectric conversion region to the first and second charge storage regions. The first and second charge storage regions may be doped with a second impurity, and the photoelectric conversion region may be doped with the second impurity and configured to receive light to generate charges.

The first transfer gate may correspond to a region between the photoelectric conversion region and the first charge storage region, and the second transfer gate may correspond to a region between the photoelectric conversion region and the second charge storage region. Each of the first and second transfer gates may be formed on a portion of the photoelectric conversion region to correspond to a region between the first and second charge storage regions.

The photoelectric conversion region may further include a region doped with the first impurity and formed on an upper portion thereof and/or an intrinsic region on a lower portion thereof. The second dielectric layer may have a width that is smaller than that of the first dielectric layer, and the first and second dielectric layers may be in a stepwise form. The second impurity of the photoelectric conversion region may have a lower concentration than that of the first and second charge storage regions. The first impurity may be a p-type impurity, and the second impurity may be an n-type impurity. The first and second transfer gates may include one of polysilicon and a metal.

According to example embodiments, a distance measuring sensor may include a detection region configured to receive light from a substrate and generate charges, first and second charge storage regions spaced apart from each other in the substrate, a first dielectric layer on the substrate and covering the first and second charge storage regions, a second dielectric layer on the first dielectric layer, and first and second transfer gates spaced apart from each other on the first dielectric layer and between the first and second charge storage regions. The substrate may be doped with a first impurity, the first and second charge storage regions may be configured to store charges and doped with a second impurity, and each of the first and second transfer gates may cover a portion of the second dielectric layer.

A photo gate may be on the second dielectric layer and between the first and second transfer gates, and the photo gate may be configured to receive the charges from the detection region. The first and second transfer gates may each be spaced apart from the photo gate. The second dielectric layer may have a width that is smaller than that of the first dielectric layer, and the first and second dielectric layers may be in a stepwise form. A third dielectric layer may be on the second dielectric layer, and each of the first and second transfer gates may cover portions of the second and third dielectric layers. A shielding part may be above the first and second transfer gates and the first and second charge storage regions, and the shielding part may be configured to shield the first and second transfer gates and the first and second charge storage regions from light.

According to example embodiments, a distance measuring sensor may include first and second charge storage regions spaced apart from each other in a substrate, a photoelectric conversion region between the first and the second charge storage regions, a first dielectric layer covering the first and second charge storage regions and the photoelectric conversion region, a second dielectric layer on the first dielectric layer, and first and second transfer gates spaced apart from each other on the first dielectric layer and covering portions of the second dielectric layer. The second dielectric layer may have a width that is smaller than that of the first dielectric layer such that the first and second dielectric layers are in a stepwise form.

A third dielectric layer may be on the second dielectric layer, and the third dielectric layer may have a width smaller than that of the second dielectric layer such that the first, second and third dielectric layers are in a stepwise form. The first, second and third dielectric layers may include an oxidizing material. A photo gate may be on the second dielectric layer and between the first and second transfer gates. The first and second transfer gates may be each spaced apart from the photo gate.

### BRIEF DESCRIPTION OF THE DRAWINGS

Example embodiments of the inventive concepts will be more clearly understood from the following detailed description taken in conjunction with the accompanying drawings in which:

FIG. 1 is a schematic plan view of a distance measuring sensor according to example embodiments of the inventive concepts;

FIG. 2 is a cross-sectional view taken along the line I-I′ of FIG. 1, according to example embodiments of the inventive concepts;

FIG. 3 is a schematic cross-sectional view of a distance measuring sensor according to example embodiments of the inventive concepts;

FIG. 4 is a schematic cross-sectional view of a distance measuring sensor according to example embodiments of the inventive concepts;

FIG. 5 is a schematic plan view of a distance measuring sensor according to example embodiments of the inventive concepts;

FIG. 6 is a cross-sectional view taken along the line II-II′ of FIG. 5, according to example embodiments of the inventive concepts;

FIG. 7 is a timing diagram for explaining an operation of a distance measuring sensor according to example embodiments of the inventive concepts;

FIG. 8 illustrates a cross-sectional view of a distance measuring sensor according to example embodiments of the inventive concepts and a graph showing a potential below transfer gates included therein;

FIG. 9 is a graph showing a transfer rate of electrons according to an operation of a distance measuring sensor including a plurality of dielectric layers stacked upon one another, according to example embodiments of the inventive concepts; and

FIGS. 10 through 12 are cross-sectional views sequentially illustrating a method of manufacturing the distance measuring sensor of FIG. 1, according to example embodiments of the inventive concepts.

### DETAILED DESCRIPTION OF EXAMPLE EMBODIMENTS

Hereinafter, example embodiments of the inventive concepts will be described in detail with reference to the accompanying drawings. However, the inventive concepts may be embodied in many different forms and should not be construed as being limited to example embodiments set forth herein. Rather, these example embodiments are provided so that this disclosure will be thorough and complete, and will fully convey the scope of the inventive concepts to those skilled in the art. As used herein, the term “and/or” includes any and all combinations of one or more of the associated listed items.

In the accompanying drawings, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. Like reference numerals refer to like constitutional elements throughout the drawings. Further, a variety of elements and regions in the drawings are schematically illustrated. Thus, the inventive concepts are not limited to the relative sizes or intervals shown in the accompanying drawings.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

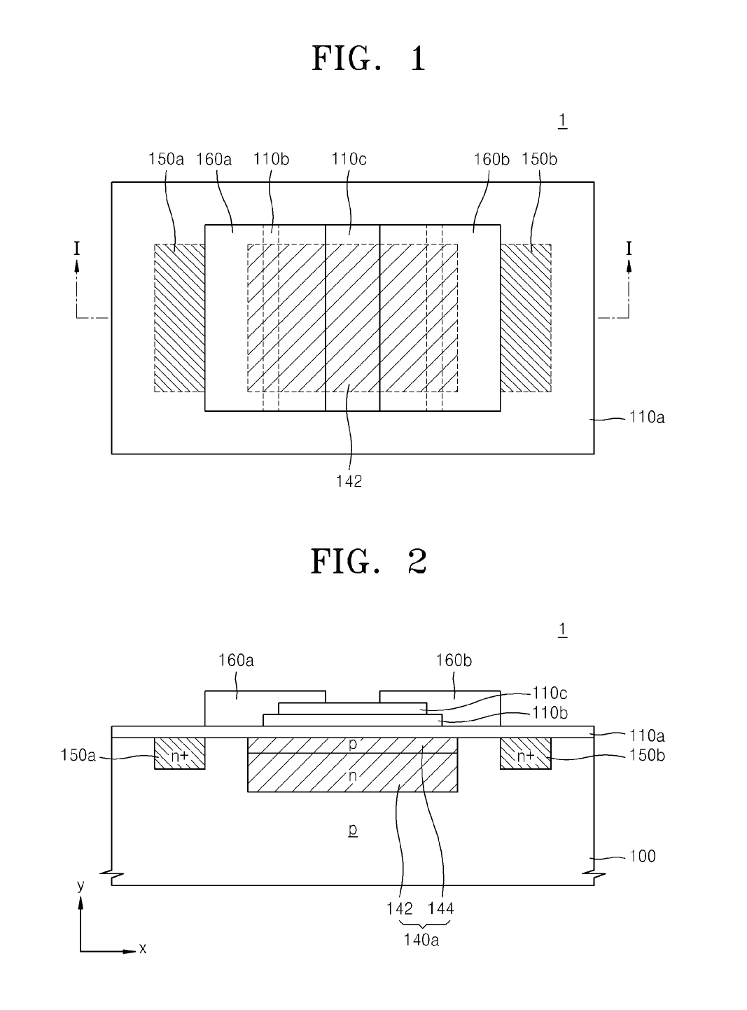

FIG. 1 is a schematic plan view of a distance measuring sensor 1 according to example embodiments of the inventive concepts, and FIG. 2 is a cross-sectional view taken along line I-I′ of FIG. 1, according to example embodiments of the inventive concepts.

Referring to FIGS. 1 and 2, the distance measuring sensor 1 includes a substrate 100, a first and second charge storage regions 150a and 150b that store charges, a photoelectric conversion region 140a that receives light to generate charges, a plurality of dielectric layers (e.g., first, second and third dielectric layers 110a, 110b and 110c) that are formed on the substrate 100, and first and second transfer gates 160a and 160b that selectively transfer the charges generated by the photoelectric conversion region 140a to the first and second charge storage regions 150a and 150b.

The substrate 100 may be a silicon substrate. Also, the substrate 100 may be a substrate doped with a first impurity. For example, the substrate 100 may be a p-type substrate. The first and second charge storage regions 150a and 150b are spaced apart from each other in the substrate 100 and store charges. The first and second charge storage regions 150a and 150b may be of an n+-type.

The photoelectric conversion region 140a may be disposed between the first and second charge storage regions 150a and 150b, and may receive light to generate charges. The photoelectric conversion region 140a may include a first photoelectric conversion region 142 doped with a second impurity, for example, an n-type region or an intrinsic region. The photoelectric conversion region 140a may further include a second photoelectric conversion region 144 formed on the first photoelectric conversion region 142. The second photoelectric conversion region 144 may be of a p-type.

The first dielectric layer 110a may be formed on the substrate 100 to cover the first and second charge storage regions 150a and 150b and the photoelectric conversion region 140a. The first dielectric layer 110a may be an insulating layer and formed of an oxidizing material.

In addition, the second dielectric layer 110b having a smaller width than that of the first dielectric layer 110a may be formed on the first dielectric layer 110a, and the third dielectric layer 110c having a smaller width than that of the second dielectric layer 110b may be formed on the second dielectric layer 110b. The first, second and third dielectric layers 110a, 110b and 110c may be in a stepwise form.

Although it is illustrated in FIGS. 1 and 2 that the second and third dielectric layers 110b and 110c are stacked on the first dielectric layer 110a, the disposition of the first, second and third dielectric layers 110a, 110b and 110c is not limited to the above example. For example, a single dielectric layer or at least three dielectric layers may be stacked on the first dielectric layer 110a in a stepwise form. In addition, as illustrated in FIGS. 1 and 2, the second dielectric layer 110b is formed on a portion of the photoelectric conversion region 140a, but is not limited to the above example. For example, the second dielectric layer 110b may completely cover the photoelectric conversion region 140a.

The first transfer gate 160a may be formed on the first dielectric layer 110a to correspond to a region between the first charge storage region 150a and the photoelectric conversion region 140a and a portion of the photoelectric conversion region 140a to cover a portion of each of the second and third dielectric layers 110b and 110c.

The second transfer gate 160b may be formed on the first dielectric layer 110a to ocrrespond to a region between the second charge storage region 150b and the photoelectric conversion region 140a and a portion of the photoelectric conversion region 140a to cover a portion of each of the second and third dielectric layers 110b and 110c, and may be spaced apart from the first transfer gate 160a.

That is, the first and second transfer gates 160a and 160b may be formed on the first dielectric layer 110a, and the first and second transfer gates 160a and 160b may be formed of polysilicon. The distance measuring sensor 1 may further include an infrared filter (not shown) and a micro lens (not shown) that are formed on the substrate 100.

The first and second charge storage regions 150a and 150b may store electrons among electron-hole pairs generated in the photoelectric conversion region 140a. When a voltage, for example, 1.8 V is applied to the first and second transfer gates 160a and 160b, the electrons generated in the photoelectric conversion region 140a pass through the first and second transfer gates 160a and 160b, are transferred to the first and second charge storage regions 150a and 150b, and are stored therein.

A distance between the distance measuring sensor 1 and an object may be measured using the amount of the charges stored in the first and second charge storage regions 150a and 150b.

Because the first, second and third dielectric layers 110a, 110b and 110c are formed in a stepwise form on the substrate 100 and the first and second transfer gates 160a and 160b are formed on the first dielectric layer 110a and spaced apart from each other, the charges generated in the photoelectric conversion region 140a may be more rapidly transferred to the first charge storage region 150a or the second charge storage region 150b. That is, by forming the plurality of stepwise dielectric layers instead of a single dielectric layer, a potential below the first and second transfer gates 160a and 160b may be controlled, which may facilitate the transfer of charges to the first charge storage region 150a or the second charge storage region 150b, and thus, may increase a demodulation speed.

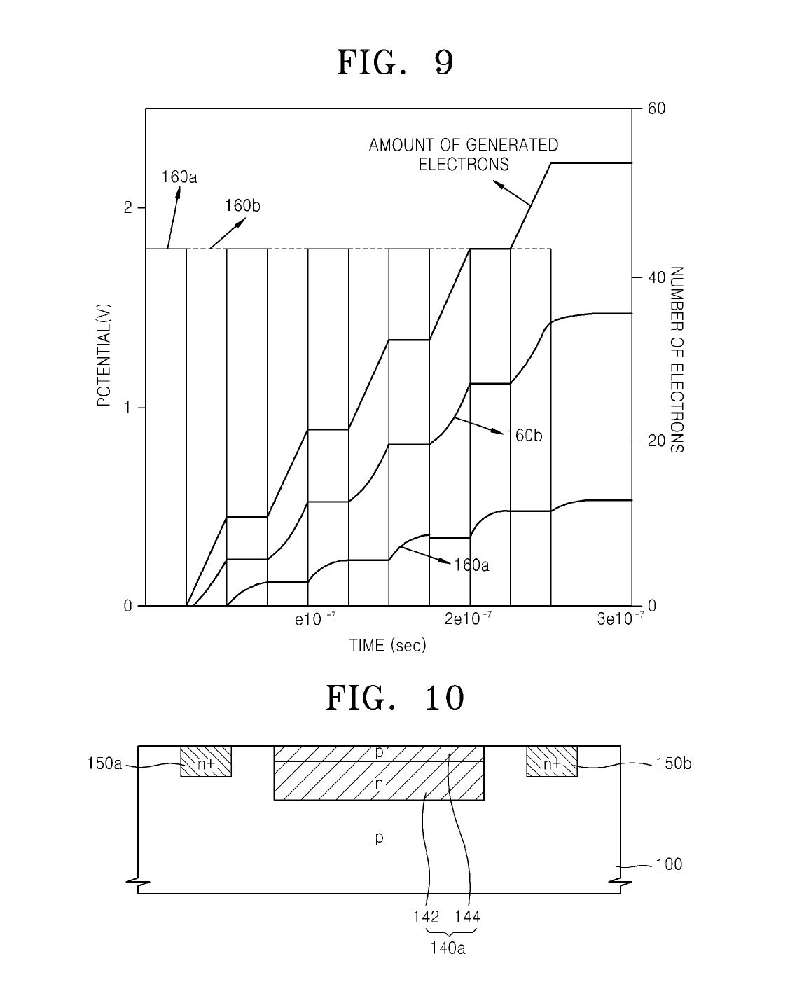

For example, when 0 V is applied to the first transfer gate 160a and a positive voltage, for example, 1.8 V is applied to the second transfer gate 160b, the thickness of the stacked dielectric layers 110a, 110b and 110c covered by the second transfer gate 160b decreases along an x-axis. The thickness of the second transfer gate 160b increases towards the second charge storage region 150b, and thus, a voltage below the second charge storage region 150b increases in a stepwise form. Therefore, the voltage below the second transfer gate 160b does not rapidly increase in an x-axis direction but increases in a stepwise form, and thus, the charges may be more easily transferred to the second charge storage region 150b. A detailed description of this operation will be described below with reference to FIGS. 9 and 10.

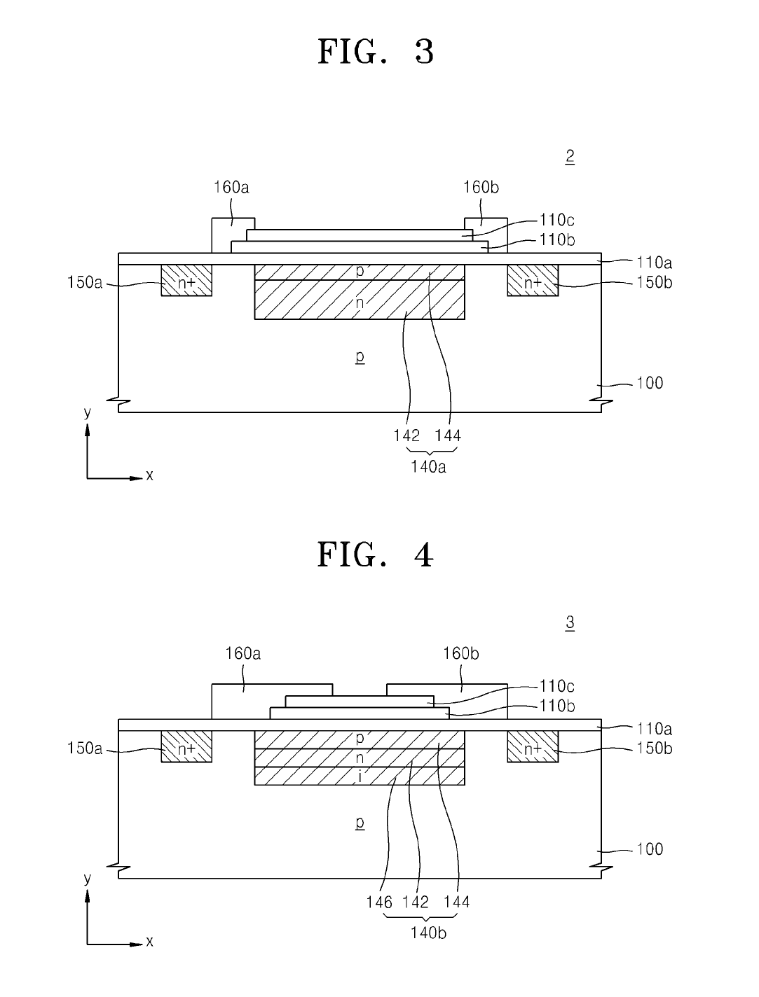

FIG. 3 is a schematic cross-sectional view of a distance measuring sensor 2 according to example embodiment of the inventive concepts. In FIG. 3, the same reference numerals as those of the distance measuring sensor 1 of FIG. 2 denote the same elements, and a detailed description thereof is not provided here.

Referring to FIG. 3, unlike as illustrated in FIG. 2, the second and third dielectric layer 110b and 110c may be formed on the first dielectric layer 110a to cover the photoelectric conversion region 140a. In addition, the first and second transfer gates 160a and 160b may be formed on the first dielectric layer 110a to respectively correspond to a region between the first charge storage region 150a and the photoelectric conversion region 140a and a region between the second charge storage region 150b and the photoelectric conversion region 140a. The first and second transfer gates 160a and 160b may cover a portion of each of the second and third dielectric layers 110b and 110c, and may be spaced apart from each other.

As described above with reference to FIGS. 1 and 2, when 0 V is applied to the first transfer gate 160a and 1.8 V is applied to the second transfer gate 160b, a potential below the second transfer gate 160b is generated in a stepwise form towards the second charge storage region 150b, and thus, the charges generated in the photoelectric conversion region 140a may be more easily transferred to the second charge storage region 150b. A detailed description of this operation is already provided above, and thus, it is not provided here.

Because the first and second transfer gates 160a and 160b respectively correspond to the region between the first charge storage region 150a and the photoelectric conversion region 140a and the region between the second charge storage region 150b and the photoelectric conversion region 140a, the photoelectric conversion region 140a may receive light without being affected by the first and second transfer gates 160a and 160b. Therefore, an area of the photoelectric conversion region 140a may be relatively increased, which results in an improved sensitivity of the distance measuring sensor 2.

In addition, because the first and second transfer gates 160a and 160b do not affect the light-receiving operation of the photoelectric conversion region 140a, the first and second transfer gates 160a and 160b may be formed using polysilicon or a metallic material through which light is unlikely to be transmitted.

FIG. 4 is a schematic cross-sectional view of a distance measuring sensor 3 according to example embodiments of the inventive concepts. In FIG. 4, the same reference numerals as those of the distance measuring sensor 1 of FIG. 2 denote the same elements, and a detailed description thereof is not provided here.

Referring to FIG. 4, a photoelectric conversion region 140b of the distance measuring sensor 3 may include a second photoelectric conversion region 144 formed in a top surface of the substrate 100, a first photoelectric conversion region 142 formed below the second photoelectric conversion region 144, and a third photoelectric conversion region 146 formed below the first photoelectric conversion region 142.

The first photoelectric conversion region 142 may be of a p-type, the second photoelectric conversion region 144 may be of an n-type, and the third photoelectric conversion region 146 may be an intrinsic region.

The first photoelectric conversion region 142, the third photoelectric conversion region 146, and the substrate 100, which is of a p-type, may have a p-i-n structure. The photoelectric conversion region 140b having the structure described above may have a relatively high light-receiving efficiency.

Other effects of the distance measuring sensor 3 are substantially the same as those of the distance measuring sensor 1 of FIG. 2, and thus, a detailed description thereof is not provided here.

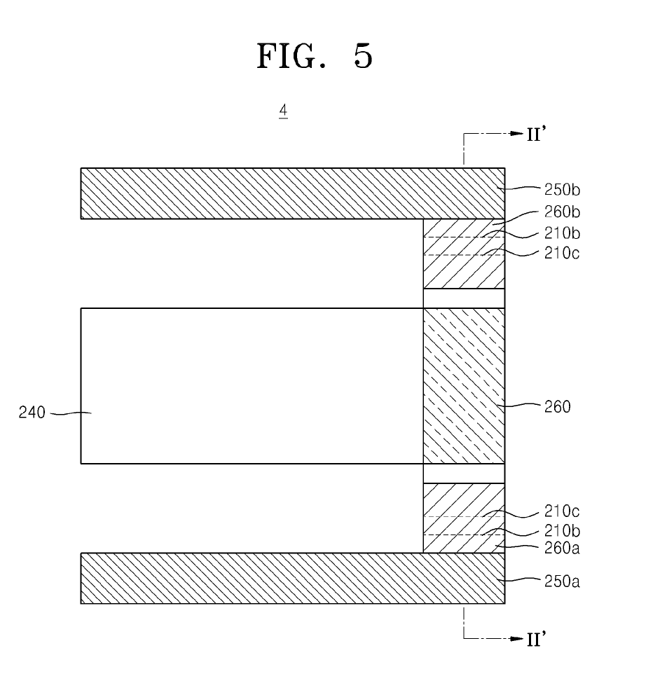

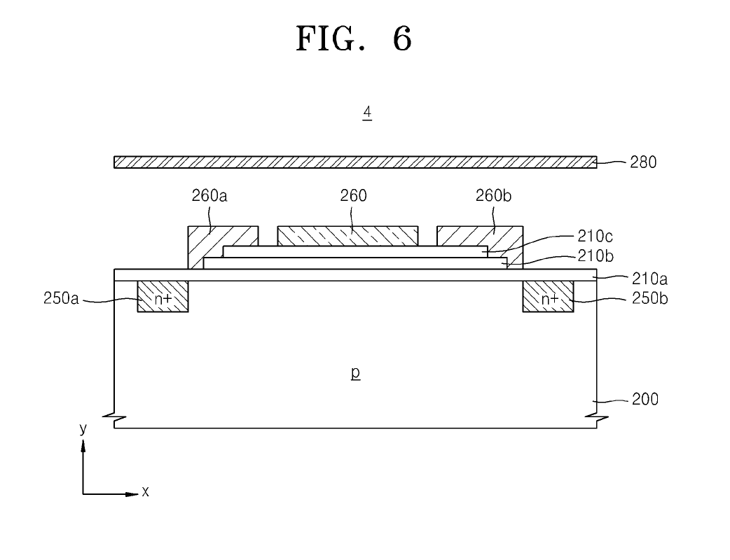

FIG. 5 is a schematic plan view of a distance measuring sensor 4 according to example embodiments of the inventive concepts, and FIG. 6 is a cross-sectional view taken along line II-II′ of FIG. 5, according to example embodiments of the inventive concepts.

Referring to FIGS. 5 and 6, the distance measuring sensor 4 includes a detection region 240, a photo gate 260, a first transfer gate 260a, a second transfer gate 260b, a first charge storage region 250a, and a second charge storage region 250b.

The detection region 240 receives light to generate charges and transfers the generated charges to the photo gate 260.

In addition, the distance measuring sensor 4 may further include a shielding part 280 that is formed above the photo gate 260, the first transfer gate 260a, the second transfer gate 260b, the first charge storage region 250a, and the second charge storage region 250b and shields them from light. The shielding part 280 may prevent or inhibit charges from being generated by light in regions except for the detection region 240. For example, the shielding part 280 may be formed of a metal, but is not limited thereto.

The photo gate 260, the first transfer gate 260a, and the second transfer gate 260b may be disposed on a substrate 200 in parallel to each other. The substrate 200 may be of a p-type.

In addition, a first dielectric layer 210a, which is an insulating layer, may be formed on the substrate 200 to cover the first charge storage region 250a and the second charge storage region 250b. The first dielectric layer 210a may be formed of an oxidizing material.

In addition, the distance measuring sensor 4 may further include a plurality of dielectric layers on the first dielectric layer that are formed in a stepwise form, e.g., a second dielectric layer 210b and a third dielectric layer 210c. The first transfer gate 260a and the second transfer gate 260b may be spaced apart from each other and cover a portion of each of the first, second and third dielectric layers 210a, 210b and 210c.

In addition, the photo gate 260 may be formed between the first and second transfer gates 260a and 260b and on a portion of the third dielectric layer 210c.

A direction of an electric field is determined according to voltages applied to the photo gate 260, the first transfer gate 260a, and the second transfer gate 260b, respectively. Electrons may migrate according to the determined direction of the electric field. The first and second transfer gates 260a and 260b may consist of polysilicon like the photo gate 260, and may also consist of other materials. When the photo gate 260 consists of a different material from that of the first and second transfer gates 260a and 260b, unlike as illustrated in FIGS. 5 and 6, there may be no gap between the photo gate 260 and the first and second transfer gates 260a and 260b. In example embodiments, electrons may be more efficiently demodulated.

The first and second charge storage regions 250a and 250b correspond to accumulating nodes that accumulate electrons transferred by the first and second transfer gates 260a and 260b. In the distance measuring sensor 4, an electric field may be applied to the detection region 240 so as to transfer electrons to the photo gate 260.

In addition, an electron transfer rate may be increased by using the photo gate 260. When a voltage applied to the photo gate 260 is set high, electrons generated in the detection region 240 may be transferred to the photo gate 260 due to a voltage difference between the photo gate 260 and the detection region 240. That is, the photo gate 260 may store the electrons generated in the detection region 240 for a certain period of time.

After the electrons are transferred to the photo gate 260, an electric field may be generated by applying 0 V to the first transfer gate 260a and applying a voltage that is higher than that of the photo gate 260 to the second transfer gate 260b while the voltage applied to the photo gate 260 is being reduced. When the electric field is generated, the electrons in the photo gate 260 may be rapidly transferred to the second charge storage region 250b.

In addition, because the first and second transfer gates 260a and 260b cover a portion of each of the first, second and third dielectric layers 210a, 210b and 210c that are formed in a stepwise form, an increase in voltage is in a stepwise form as described above with reference to FIGS. 1 and 2. Therefore, electrons may be more easily transferred to a desired charge storage region.

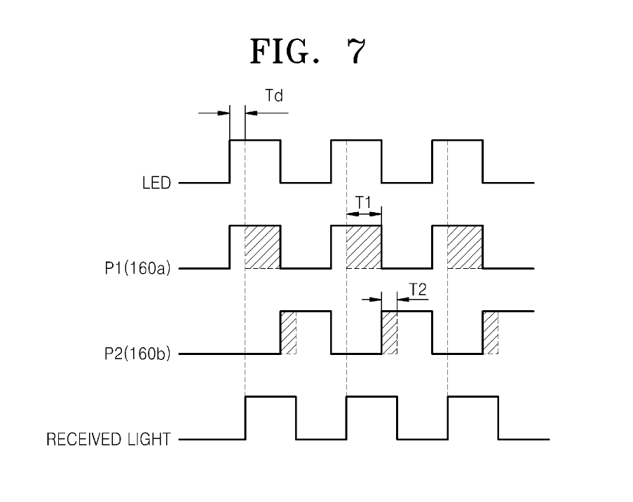

FIG. 7 is a timing diagram for explaining an operation of a distance measuring sensor according to example embodiments of the inventive concepts. Hereinafter, the operation of the distance measuring sensor will be described in detail with reference to FIGS. 2 and 7.

A light-emitting device (not shown) irradiates infrared rays onto an object. The light-emitting device emits a pulse optical signal according to a pulse voltage. In this regard, a first pulse voltage synchronized with the pulse optical signal may be applied to the first transfer gate 160a, and a second pulse voltage having a predetermined or given phase difference from the pulse optical signal may be applied to the second transfer gate 160b. The phase difference may be 180°.

The infrared light is incident on the object positioned at a predetermined or given distance from the light-emitting device, and the infrared light reflected from the object is incident on the distance measuring sensor 1. The infrared light may be incident on the distance measuring sensor 1 by being delayed according to a distance of the object from the distance measuring sensor 1.

The infrared light incident on the first and second transfer gates 160a and 160b may be detected in a pulse form having a time delay Td compared to the pulse signal of the first transfer gate 160a. The measured distance of the object may be shorter when a difference (T1−T2) between a time T1, wherein the pulse signal of the infrared light and the pulse voltage of the first transfer gate 160a overlap, and a time T2, wherein the pulse signal of the infrared light and the pulse voltage of the second transfer gate 160b overlap, increases.

When the first pulse voltage, which is a positive voltage, is applied to the first transfer gate 160a, the charges generated in the photoelectric conversion region 140a may be transferred to the first charge storage region 150a. When the second pulse voltage having the phase difference of 180° from the first pulse voltage of the first transfer gate 160a is applied to the second transfer gate 160b, the charges generated in the photoelectric conversion region 140a may be transferred to the second charge storage region 150b. A circuit processor (not shown) of the distance measuring sensor 1 may determine the distance between the object and the distance measuring sensor 1 by using the charges stored in the first and second charge storage regions 150a and 150b.

Because the distance measuring sensor 1 includes the plurality of dielectric layers formed in a stepwise form, the charges generated in the photoelectric conversion region 140a may be stably and rapidly transferred to the first and second charge storage regions 150a and 150b. Thus, a demodulation speed may be increased.

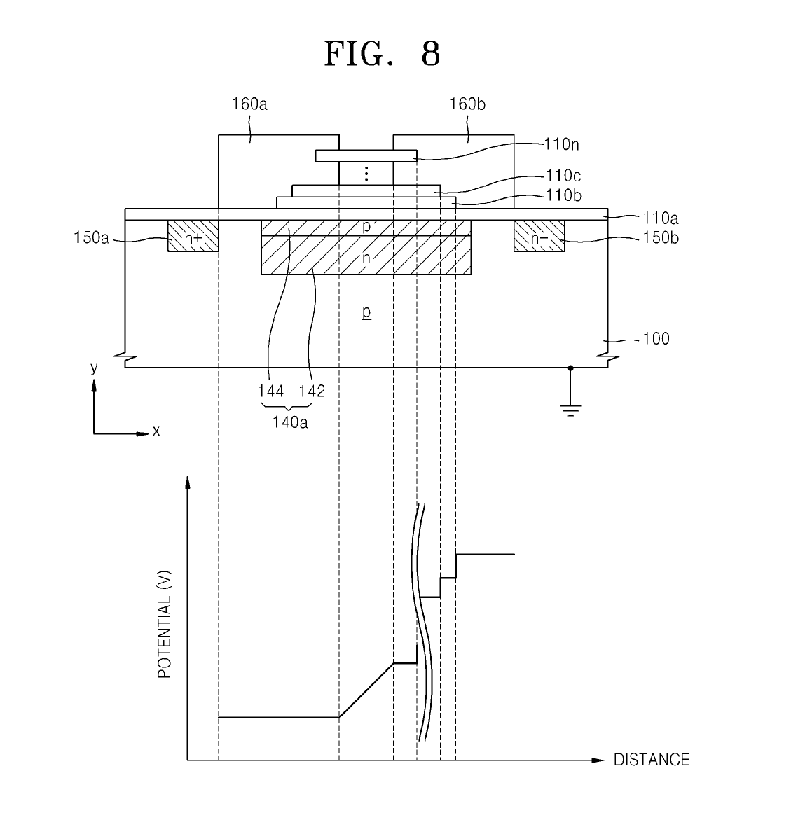

FIG. 8 illustrates a cross-sectional view of a distance measuring sensor according to example embodiments of the inventive concepts and a graph showing a potential below transfer gates included therein.

In example embodiments, changes in potential below the second transfer gate 160b when 0 V is applied to the first transfer gate 160a and a positive voltage, for example, 1.8 V is applied to the second transfer gate 160b, that is, when the first transfer gate 160a is set in an off-state and the second transfer gate 160b is set in an on-state will be described with reference to FIG. 8.

Referring to FIG. 8, the potential below the second transfer gate 160b increases in a stepwise form towards the second charge storage region 150b. That is, as the thickness of the dielectric layers 110a, 110b, 110c, . . . and 110n covered by the second transfer gate 160b decreases in a stepwise form, the thickness of the second transfer gate 160b increases and the potential below the second transfer gate 160b increases in a stepwise form.

By adjusting the thickness and number of the dielectric layers 110a, 110b, 110c, . . . and 110n, a potential increase from the second transfer gate 160b to the second charge storage region 150b may be controlled. Thus, unlike a case where when only a first dielectric layer 110a is formed, a potential in the vicinity of the second charge storage region 150b sharply increases, when the plurality of dielectric layers 110b, 110c, . . . and 110n are formed on the first dielectric layer 110a, the potential below the second transfer gate 160b increases in a stepwise form. Therefore, electrons generated in the photoelectric conversion region 140a may be more easily and rapidly transferred to the second charge storage region 150b. Accordingly, the demodulation is increased, which results in improved performances of the distance measuring sensor.

FIG. 9 is a graph showing a transfer rate of electrons according to an operation of a distance measuring sensor including a plurality of dielectric layers stacked upon one another, according to example embodiments of the inventive concepts.

Referring to FIG. 9, when a positive voltage, for example, 1.8 V, is applied to the first transfer gate 160a, electrons are not generated, and on the other hand, when a positive voltage, for example, 1.8 V, is applied to the second transfer gate 160b, electrons are generated. That is, a positive voltage may be consecutively applied to the first and second transfer gates 160a and 160b. In this regard, the case where the positive voltage is applied to the first transfer gate 160a is considered as a dark condition, and the case where the positive voltage is applied to the second transfer gate 160b is considered as a light condition.

As the positive voltage is applied to the second transfer gate 160b, the amount of electrons generated in the photoelectric conversion region 140a (refer to FIG. 1) increases, and the number of the electrons that are transferred to the second transfer gate 160b also increases.

A demodulation contrast (e.g., (the number of electrons transferred to the second transfer gate−the number of electrons transferred to the first transfer gate)/(the number of electrons transferred to the second transfer gate+the number of electrons transferred to the first transfer gate)) of the distance measuring sensor is about 46.5%, and an electron transfer rate (e.g., (the number of electrons transferred to the first transfer gate+the number of electrons transferred to the second transfer gate)/(amount of generated electrons)) of the distance measuring sensor is 90.3%.

As in example embodiments of the inventive concepts, when the distance measuring sensor includes the plurality of dielectric layers formed in a stepwise form, the demodulation contrast and the electron transfer rate of the distance measuring sensor may be increased, and thus, the distance measuring sensor may exhibit improved performances.

FIGS. 10 through 12 are cross-sectional views sequentially illustrating a method of manufacturing the distance measuring sensor 1 of FIG. 1, according to example embodiments of the inventive concepts.

Referring to FIG. 10, the substrate 100 is prepared. The substrate 100 may be a silicon substrate and a p-type substrate. The photoelectric conversion region 140a may be formed on the substrate 100. The photoelectric conversion region 140a may include a first photoelectric conversion region 142 doped with an n-type impurity, and may further include a second photoelectric conversion region 144 doped with a p-type impurity.

The first and second charge storage regions 150a and 150b are formed to be spaced apart from the photoelectric conversion region 140a at predetermined or given intervals. In example embodiments, the first and second charge storage regions 150a and 150b are formed after the photoelectric conversion region 140a is formed. However, the order of the forming processes listed above is not limited thereto, and may vary according to the manufacturing of the distance measuring sensor.

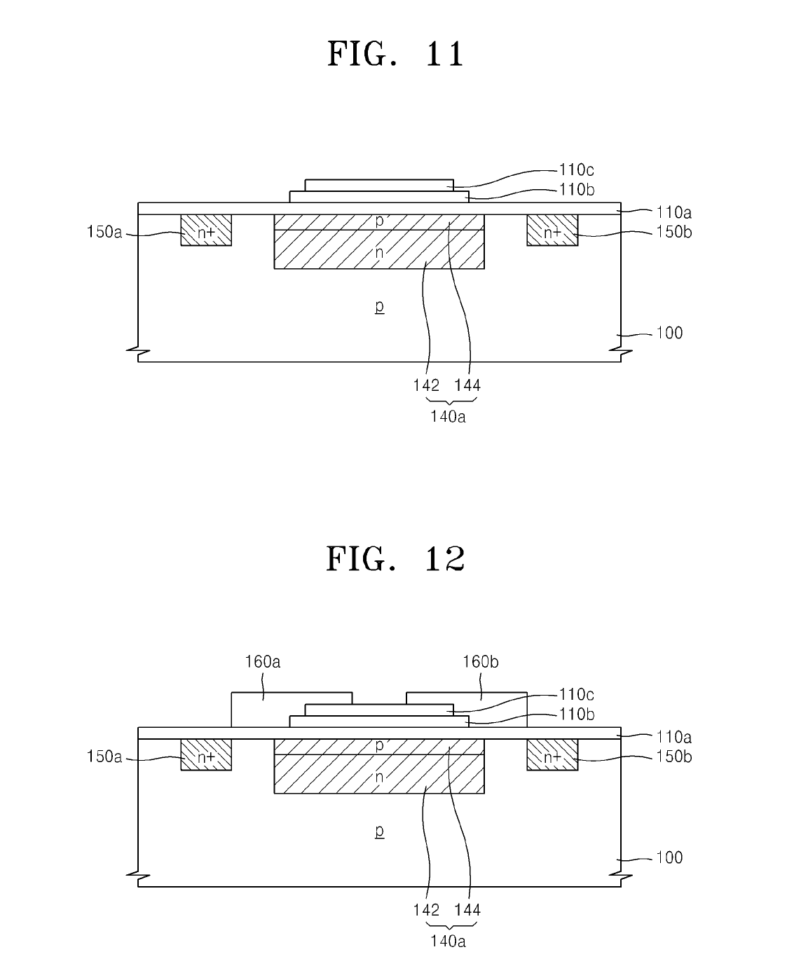

Referring to FIG. 11, the first dielectric layer 110a may be formed on the substrate 100 to cover the first and second charge storage regions 150a and 150b and the photoelectric conversion region 140a.

The first dielectric layer 110a, which is an insulating layer, may be formed of an oxidizing material.

The second dielectric layer 110b and the third dielectric layer 110c may be sequentially formed on the first dielectric layer 110a. The second and third dielectric layers 110b and 110c may be formed of an oxidizing material. In FIG. 11, the two dielectric layers are formed on the first dielectric layer 110a, but the number of dielectric layers is not limited thereto. For example, a single dielectric layer may be formed on the first dielectric layer 110a or at least three dielectric layers may be stacked on the first dielectric layer 110a in a stepwise form.

Referring to FIG. 12, the first transfer gate 160a and the second transfer gate 160b may be formed on the first dielectric layer 110a, each covering a portion of each of the second and third dielectric layers 110b and 110c, and may be spaced apart from each other.

Because each of the first and second transfer gates 160a and 160b cover the portions of the second and third dielectric layers 110b and 110c, the thickness of each of the first and second transfer gates 160a and 160b may vary in an x-axis direction. Therefore, a potential below the first and second transfer gates 160a and 160b may be formed in a stepwise form due to the thickness difference.

While the inventive concepts have been particularly shown and described with reference to example embodiments thereof, it will be understood that various changes in form and details may be made therein without departing from the spirit and scope of the following claims.

What is claimed is:

1. A distance measuring sensor comprising:
a substrate doped with a first impurity;
first and second charge storage regions spaced apart from each other in the substrate, the first and second charge storage regions doped with a second impurity;
a photoelectric conversion region between the first and the second charge storage regions, the photoelectric conversion region doped with the second impurity and configured to receive light to generate charges;
a first dielectric layer covering the first and second charge storage regions and the photoelectric conversion region;
a second dielectric layer on the first dielectric layer; and
first and second transfer gates spaced apart from each other on the first dielectric layer and between the first and second charge storage regions, each of the first and second transfer gates covering a portion of the second dielectric layer and configured to selectively transfer the charges generated in the photoelectric conversion region to the first and second charge storage regions.

2. The distance measuring sensor of claim 1, wherein the first transfer gate corresponds to a region between the photoelectric conversion region and the first charge storage region, and the second transfer gate corresponds to a region between the photoelectric conversion region and the second charge storage region.

3. The distance measuring sensor of claim 1, wherein each of the first and second transfer gates is formed on a portion of the photoelectric conversion region to correspond to a region between the first and second charge storage regions.

4. The distance measuring sensor of claim 1, wherein the photoelectric conversion region further comprises a region doped with the first impurity and formed on an upper portion thereof.

5. The distance measuring sensor of claim 4, wherein the photoelectric conversion region further comprises an intrinsic region on a lower portion thereof.

6. The distance measuring sensor of claim 1, wherein the second dielectric layer has a width that is smaller than that of the first dielectric layer, and the first and second dielectric layers are in a stepwise form.

7. The distance measuring sensor of claim 1, wherein the second impurity of the photoelectric conversion region has a lower concentration than that of the first and second charge storage regions.

8. The distance measuring sensor of claim 1, wherein the first impurity is a p-type impurity, and the second impurity is an n-type impurity.

9. The distance measuring sensor of claim 1, wherein the first and second transfer gates include one of polysilicon and a metal.

10. A distance measuring sensor comprising:
a detection region configured to receive light from a substrate and generate charges, the substrate doped with a first impurity;
first and second charge storage regions spaced apart from each other in the substrate, the first and second charge storage regions configured to store charges and doped with a second impurity;
a first dielectric layer on the substrate and covering the first and second charge storage regions;
a second dielectric layer on the first dielectric layer; and
first and second transfer gates spaced apart from each other on the first dielectric layer and between the first and second charge storage regions, each of the first and second transfer gates covering a portion of the second dielectric layer.

11. The distance measuring sensor of claim 10, further comprising:
a photo gate on the second dielectric layer and between the first and second transfer gates, the photo gate configured to receive the charges from the detection region.

12. The distance measuring sensor of claim 11, wherein the first and second transfer gates are each spaced apart from the photo gate.

13. The distance measuring sensor of claim 10, wherein the second dielectric layer has a width that is smaller than that of the first dielectric layer, and the first and second dielectric layers are in a stepwise form.

14. The distance measuring sensor of claim 10, further comprising:
a third dielectric layer on the second dielectric layer, wherein each of the first and second transfer gates covers portions of the second and third dielectric layers.

15. The distance measuring sensor of claim 10, further comprising:
a shielding part above the first and second transfer gates and the first and second charge storage regions, the shielding part configured to shield the first and second transfer gates and the first and second charge storage regions from light.

16. A distance measuring sensor comprising:
first and second charge storage regions spaced apart from each other in a substrate;
a photoelectric conversion region between the first and the second charge storage regions;
a first dielectric layer covering the first and second charge storage regions and the photoelectric conversion region;
a second dielectric layer on the first dielectric layer; and
first and second transfer gates spaced apart from each other on the first dielectric layer and covering portions of the second dielectric layer,
wherein the second dielectric layer has a width that is smaller than that of the first dielectric layer such that the first and second dielectric layers are in a stepwise form.

17. The distance measuring sensor of claim 16, further comprising:
a third dielectric layer on the second dielectric layer, wherein the third dielectric layer has a width smaller than that of the second dielectric layer such that the first, second and third dielectric layers are in a stepwise form.

18. The distance measuring sensor of claim 16, wherein the first, second and third dielectric layers include an oxidizing material.

19. The distance measuring sensor of claim 16, further comprising:
a photo gate on the second dielectric layer and between the first and second transfer gates.

20. The distance measuring sensor of claim 19, wherein the first and second transfer gates are each spaced apart from the photo gate.
